(19) United States
(12) Patent Application Publication
(10) Pub. No.: US 2007/0023607 A1
(43) Pub. Date: Feb. 1, 2007

(54) Cupcake stand

(76) Inventor: Catherine Franczyk, Woodridge, IL (US)

Correspondence Address: PATENT GROUP;ATTN: J. KENNETH JOUNG, DLA PIPER RUDNICK GRAY CARY US LLP, 203 N. LASALLE ST., SUITE 1900, CHICAGO, IL, 60601, US

(21) Appl. No.: 11/484,113

(22) Filed: Jul. 11, 2006

Related U.S. Application Data
(60) Provisional application No. 60/698,130, filed on Jul. 11, 2005.

(51) Int. Cl. F16M 13/00

(52) U.S. Cl. 248/527

(57) ABSTRACT

A stand for holding and displaying a food item, such as a cupcake or muffin, includes a generally vertical trunk and at least one branch having an arm portion and a spiral portion with the arm portion connected to the trunk so that the branch extends radially outwards from the trunk. The spiral portion features coils sized to support the desert item. A base is attached to the trunk so that the stand may be supported on a generally horizontal surface. The inner coils of the spiral portion of the branch are bent downwards at an angle so that the food item is tipped for facilitated viewing.

### CLAIM OF PRIORITY

This application claims priority from U.S. Provisional Patent Application Ser. No. 60/698,130, filed Jul. 11, 2005.

### FIELD OF THE INVENTION

The present invention relates generally to a holder for cupcakes, muffins and the like and, more particularly, to a decorative stand for displaying cupcakes, muffins and the like.

### BRIEF DESCRIPTION OF THE DRAWINGS

FIG. 1 is a perspective view of a first embodiment of the cupcake stand of the present invention;

FIG. 2 is an exploded perspective view of the cupcake stand of FIG. 1;

FIG. 3 is an enlarged perspective view of one of the branches of the cupcake stand of FIGS. 1 and 2;

FIG. 4 is a perspective view of a second embodiment of the cupcake stand of the present invention.

### DETAILED DESCRIPTION OF EMBODIMENTS

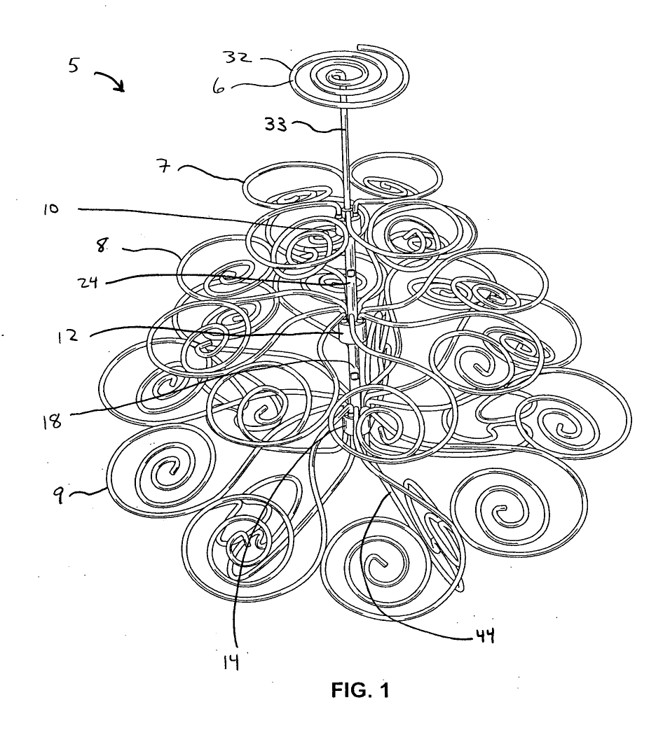

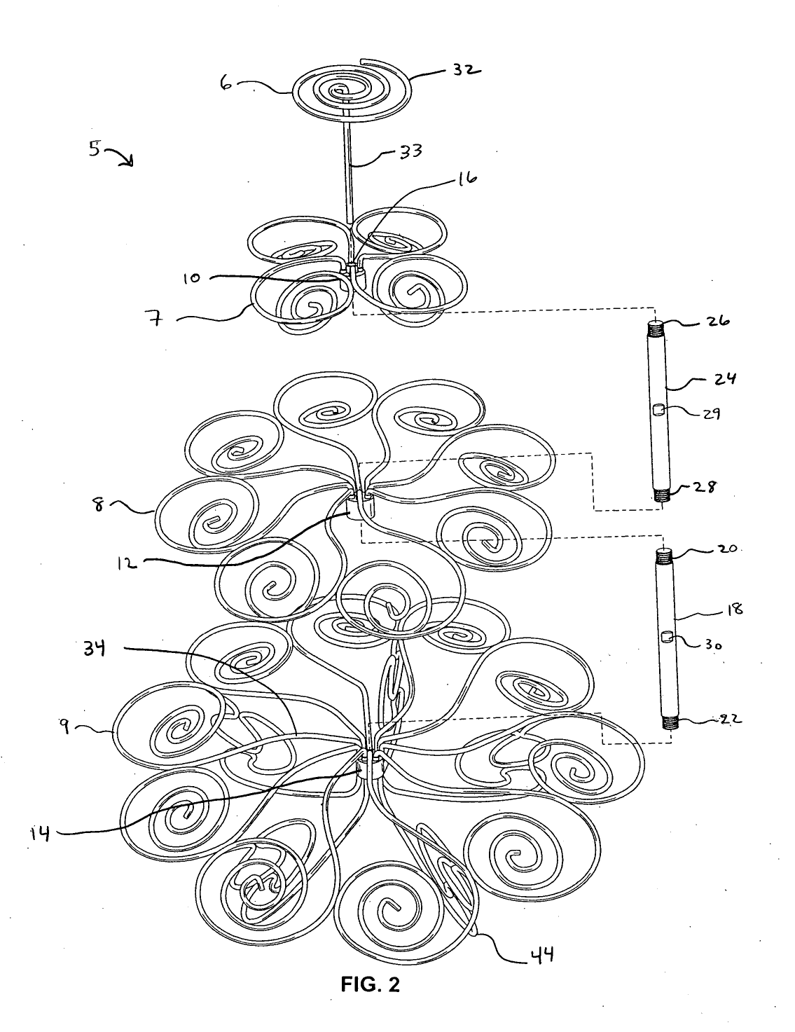

An embodiment of the cupcake stand of the invention is indicated in general at 5 in FIGS. 1 and 2. As indicated in FIGS. 1 and 2, the cupcake stand 5 includes tiers 6, 7, 8 and 9. While the cupcake stand is described below in terms of holding cupcakes, it is to be understood that the stand could be used to hold other desert items or food items such as muffins.

Each of the bottom three tiers 7, 8 and 9 of the cupcake stand 5 features a central hub, illustrated at 10, 12 and 14, respectively, with a threaded bore formed therein (illustrated at 16 in FIG. 2 for hub 10). Each hub is preferably constructed from steel. A first vertical shaft 18 features threaded ends, illustrated at 20 and 22 in FIG. 2, that screw into the top portion of the bore of hub 14 and the bottom portion of the bore of hub 12. A second vertical shaft 24 features threaded ends 26 and 28 that screw into the top portion of the bore of hub 12 and the bottom portion of the bore of hub 10. As a result, the assembled shafts and hubs form a central, generally vertical trunk with tiers 7, 8 and 9 vertically spaced from one another.

Both shafts 18 and 24 are preferably constructed from steel. Each one of the shafts also preferably includes notches 29 and 30 so that the shaft may be engaged and turned by a small wrench or other tool for assembly of the stand. Shafts 18 and 24 could be replaced with a single, vertical shaft as the trunk in an alternative embodiment of the invention.

As illustrated in FIGS. 1 and 2, the three bottom tiers of the stand 7, 8 and 9 increase in horizontal diameter going from the top to the bottom of the stand. A single spiral holder 32 serves as the highest tier 6 of the stand and is positioned on the top end of a vertical shaft or wire 33 that engages the top portion of the bore 16 of hub 10.

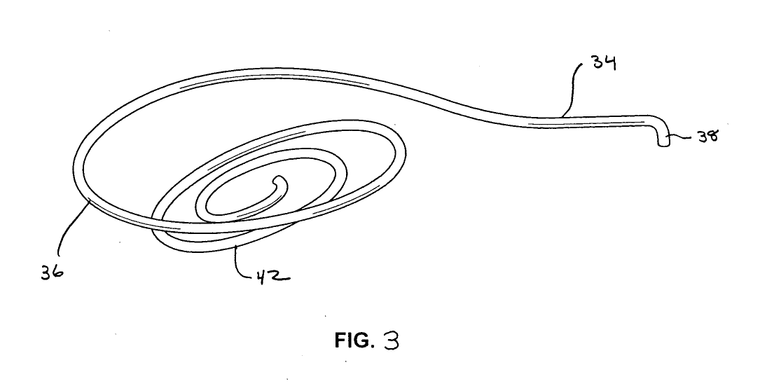

Each of the three lower tiers features multiple branches constructed of wire. An enlarged view of one of the branches of the lowest tier is illustrated in FIG. 3. The wire is preferably steel and features an arm portion, illustrated at 34, and a spiral portion, illustrated at 36. The inner end 38 of the arm 34 is bent downwards and engages a corresponding opening in hub 14 (FIGS. 1 and 2). The end 38 is then preferably soldered in place. It should be noted, however, that alternative attachment arrangements known in the art may be used to attach the branches to the hubs. Multiple branches are connected to each hub in a circumferential fashion so that the branches extend in a radial fashion to form a tier. The spiral portions of adjacent branches may be soldered together in the manner illustrated in FIGS. 1 and 2 to enhance the structural rigidity of the stand.

As an alternative to the hubs, the branches could be attached directly to the trunk of the stand, that is, the vertical shafts 18 and 24 or a single, central vertical shaft.

As illustrated best in FIG. 3, the inner-most coils 42 of each spiral portion are preferably bent downwards at an angle so that the spiral forms a holder which may cradle a cupcake or similar food item. The inner coils 42 of the spiral holders are preferably bent with an angle that is oriented so that the top surfaces of cupcakes positioned therein are tipped outward for facilitated viewing.

As illustrated at 44 in FIGS. 1 and 2, a number of wire legs are also attached to the bottom side of hub 14, in a fashion similar to the way the branches are attached, to form a base so that the stand may be supported on a generally horizontal surface. The legs are preferably made of wire and may alternatively be attached directly to the trunk of the stand. The legs may be soldered to the branches of the above tier to increase structural rigidity of the stand. While the base of the stand of FIGS. 1 and 2 consists of a number of legs, it is to be understood that the base of the stand of the invention could take other forms including, but not limited to, a disc-shaped or conical-shaped base.

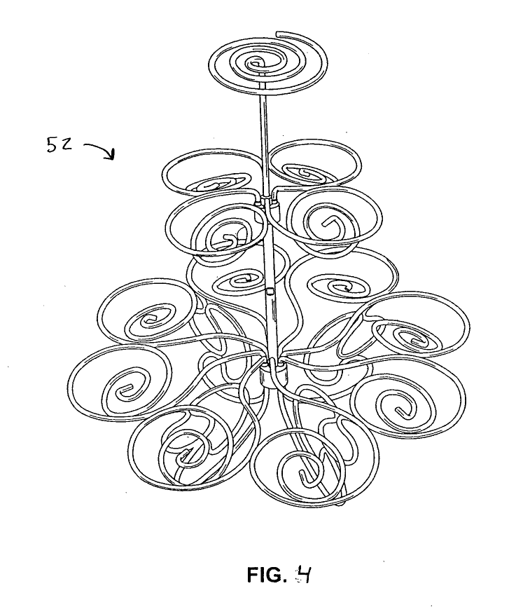

While the embodiment illustrated in FIGS. 1 and 2 features four tiers and will hold twenty-three cupcakes, it is to be understood that the stand may feature an alternative number of tiers and may accommodate an alternative number of cupcakes or other food items. For example, the embodiment indicated in general at 52 in FIG. 4 accommodates thirteen cupcakes and features three tiers.

The present invention thus provides a stand that, when loaded with cupcakes or other food items, creates an attractive display which also offers easy access to the desert items.

While embodiments of the invention have been shown and described, it will be apparent to those skilled in the art that changes and modifications may be made therein without departing from the spirit of the invention.

What is claimed is:

1. A stand for holding and displaying a desert item comprising:
a. a generally vertical trunk;
b. at least one branch having an arm portion and a spiral portion with the arm portion connected to the trunk so that the branch extends radially outwards from the trunk and where the spiral portion features coils sized to support the desert item; and
c. a base attached to the trunk so that the stand may be supported on a generally horizontal surface.

2. The stand of claim 1 wherein the branch is constructed from wire.

3. The stand of claim 1 wherein inner coils of the spiral portion of the branch are bent downwards at an angle so that the desert item is tipped for facilitated viewing.

4. The stand of claim 1 wherein the trunk includes a hub to which said branch is attached and a generally vertical shaft attached to the hub.

5. The stand of claim 4 wherein the hub includes a threaded bore and the generally vertical shaft includes a threaded end that engages the bore.

6. The stand of claim 5 wherein the vertical shaft includes notches so that the shaft may be engaged and turned by a small wrench for assembly of the stand.

7. The stand of claim 4 wherein the vertical shaft is made of steel.

8. The stand of claim 4 wherein the hub includes a bore and a spiral holder serves as a highest tier of the stand and is positioned on a top end of a vertical wire that engages the bore of the hub.

9. The stand of claim 1 wherein the base includes legs.

10. The stand of claim 9 wherein the legs are constructed of wire.
